(19) United States
(12) Patent Application Publication
(10) Pub. No.: US 2015/0115580 A1
(43) Pub. Date: Apr. 30, 2015

(54) COMBINATION PASSENGER AIR BAG AND KNEE AIR BAG

(71) Applicant: TRW Vehicle Safety Systems Inc., Washington, MI (US)

(72) Inventors: Douglas M. Gould, Lake Orion, MI (US); Bernd Ibler, Schorndorf (DE); Werner Freisler, Huebach (DE); Joseph Popek, Shelby Township, MI (US)

(21) Appl. No.: 14/527,414

(22) Filed: Oct. 29, 2014

Related U.S. Application Data
(60) Provisional application No. 61/896,785, filed on Oct. 29, 2013.

(51) Int. Cl. B60R 21/206; B60R 21/231

(52) U.S. Cl. CPC B60R 21/206; B60R 21/231
USPC 280/730.1

(57) ABSTRACT

An apparatus (10) for helping to protect an occupant (20) of a vehicle (12) includes an air bag (16) inflatable between the occupant's head/torso and an instrument panel (36) of the vehicle (12). A knee bolster (18) is inflatable between the occupant's legs/pelvis and the instrument panel (36). A flexible housing (32) supports both the air bag (16) and the knee bolster (18) within the instrument panel (36).

### RELATED APPLICATIONS

This application claims the benefit of U.S. Provisional Application Ser. No. 61/896,785, filed Oct. 29, 2013, the entirety of which is incorporated herein by reference.

### FIELD OF THE INVENTION

The present invention relates to an apparatus for helping to protect an occupant of a vehicle. More particularly, the present invention relates to an air bag inflatable between an instrument panel and a front seat occupant of a vehicle.

### BACKGROUND OF THE INVENTION

It is known to provide an inflatable vehicle occupant protection device, such as an air bag, for helping to protect an occupant of a vehicle. One particular type of air bag is a frontal air bag inflatable between an occupant of a front seat of the vehicle and an instrument panel of the vehicle. Such air bags can be driver air bags or passenger air bags. When inflated, the driver and passenger air bags help protect the occupant from impacts with parts of the vehicle, such as the instrument panel and/or a steering wheel.

Passenger air bags are typically stored in a deflated condition in a housing mounted to the vehicle instrument panel. An air bag door is connectable with the housing and/or instrument panel to help enclose and conceal the air bag in a stored condition. Upon deployment of the passenger air bag, the air bag door opens to permit the air bag to move to an inflated position. The air bag door opens as a result of forces exerted on the door by the inflating air bag.

Driver air bags are typically stored in a deflated condition in a housing mounted on the vehicle steering wheel. An air bag cover is connectable with the housing and/or steering wheel to help enclose and conceal the air bag in a stored condition. Upon deployment of the driver air bag, the air bag cover opens to permit the air bag to move to an inflated position. The air bag cover opens as a result of forces exerted on the cover by the inflating driver air bag.

Additionally, during a vehicle collision, it is possible that the instrument panel can impact the vehicle occupant's knees. When this occurs, forces on the occupant's lower extremities can be transmitted through the occupant's legs to the occupant's pelvis and cause injuries to the occupant's hip and/or pelvic areas. Accordingly, an air bag in the form of an inflatable knee bolster can be positioned in the area of the lower portion of the instrument panel and the vehicle footwell to help protect the knees, legs, and hips of the vehicle occupant during a collision.

### SUMMARY OF THE INVENTION

An apparatus for helping to protect an occupant of a vehicle includes an air bag inflatable between an occupant's head/torso and an instrument panel of the vehicle. A knee bolster is inflatable between the occupant's legs/pelvis and the instrument panel. A flexible housing supports both the air bag and the knee bolster within the instrument panel.

In accordance with another embodiment, an apparatus for helping to protect an occupant of a vehicle includes an air bag inflatable between an occupant's head/torso and an instrument panel of the vehicle. A knee bolster is inflatable between the occupant's legs/pelvis and the instrument panel. The air bag and knee bolster being integrally formed together and cooperating to define a single inflatable volume. A fabric housing supports both the air bag and the knee bolster within the instrument panel.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic illustration of an apparatus for helping to protect an occupant of a vehicle in accordance with an embodiment of the present invention.

FIG. 2 is a schematic illustration of the apparatus of FIG. 1 in an unactuated condition.

FIG. 3 is an exploded assembly view of the apparatus of FIG. 1.

FIG. 4A is a schematic illustration of a flexible housing of the apparatus of FIG. 1.

FIG. 4B is a section view of the housing of FIG. 4A taken along line 4B-4B.

FIG. 5 is a rear view of the apparatus of FIG. 1 secured to the vehicle.

FIG. 6A is a schematic illustration of a flexible housing in accordance with another embodiment of the present invention.

FIG. 6B is a section view of the housing of FIG. 6A taken along line 6B-6B.

FIG. 7 is a schematic illustration of the apparatus of FIG. 6A secured to the vehicle.

FIG. 8 is a rear view of the apparatus of FIG. 7

### DESCRIPTION OF THE INVENTION

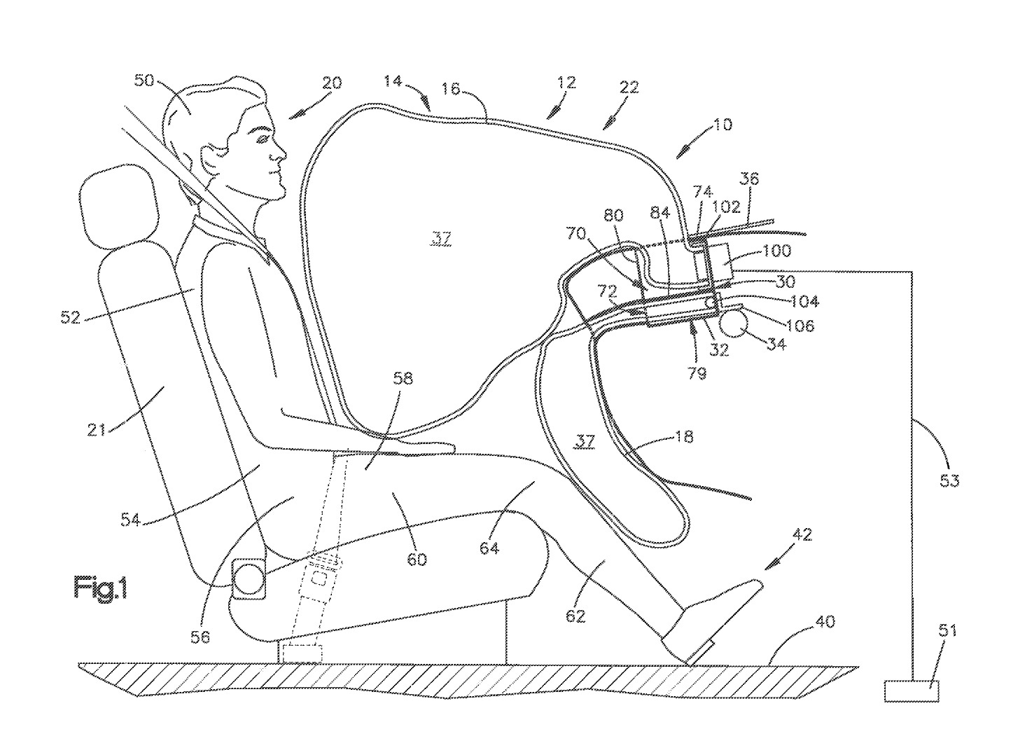

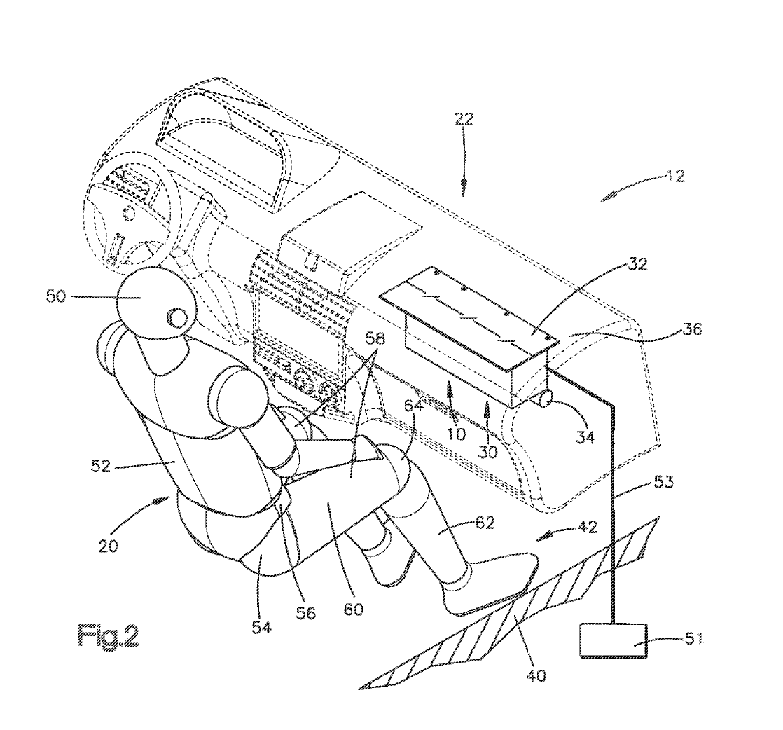

The present invention relates to an apparatus for helping to protect an occupant of a vehicle. More particularly, the present invention relates to an air bag inflatable between an instrument panel and a front seat occupant of a vehicle. Referring to FIGS. 1 and 2, the apparatus 10 is a passenger frontal protection device for helping to protect an occupant 20 in a vehicle seat 21 on a passenger side 22 of the vehicle 12. The apparatus 10 includes an inflatable vehicle occupant protection device 14 in the form of a passenger air bag 16 and a knee bolster 18. The occupant 20 has a head 50, a torso 52, a pelvic area 54, which includes hips 56, and a pair of legs 58 extending from the hips. Each leg 58 includes an upper leg portion 60 and a lower leg portion 62 interconnected at a knee 64. The vehicle 10 also includes a floorboard 40 and a footwell 42 partially defined by the floorboard for receiving the lower leg portions 62 of the occupant 20.

An airbag module 30 receives and stores the air bag 16 and knee bolster 18 for inflation and deployment toward the occupant 20. The module 30 includes a housing 32 that receives and stores the air bag 16 and knee bolster 18 and one or more inflators 100, 104 (not shown in FIGS. 1 and 2) for inflating the air bag and the knee bolster, respectively. The protection device 14 has a stored condition, shown in FIG. 2, in which both the air bag 16 and knee bolster 18 are folded and placed in the housing 32. The module 30 is mounted to vehicle structure 34 located on or within an instrument panel 36 of the vehicle 12 facing the occupant 20 and above the footwell 42. The housing 32 therefore helps contain and support the protection device 14 and inflators 100, 104 in the instrument panel 36.

The protection device 14, i.e., the air bag 16 and the knee bolster 18, can be constructed of any suitable material, such as nylon (e.g., woven nylon 6-6 yarns), and can be constructed in any suitable manner. For example, the protection device 14 can include one or more pieces or panels of material. If more than one piece or panel is used, the pieces or panels can be interconnected by known means, such as stitching, ultrasonic welding, heat bonding, or adhesives, to form the air bag. The protection device 14 can be uncoated, coated with a material, such as a gas impermeable urethane, or laminated with a material, such as a gas impermeable film. The protection device 14 thus can have a gas-tight or substantially gas-tight construction. Those skilled in the art will appreciate that alternative materials, such as polyester yarn, and alternatives coatings, such as silicone, can also be used to construct the protection device 14.

The air bag 16 and knee bolster 18 can be formed as separate components having fluidly isolated inflatable volumes 37. To this end, the inflators 100, 104 are actuatable to provide inflation fluid to inflate and deploy the air bag 16 and knee bolster 18, respectively, to the inflated condition. The inflators 100, 104 can each be of any known type, such as stored gas, solid propellant, augmented or hybrid. The apparatus 10 includes a sensor 51 for sensing an event for which deployment of the protection device 14 is desired, such as a collision. The inflators 100, 104 are operatively connected to the sensor 51 via known means, such as lead wires 53.

Upon sensing the occurrence of an event for which deployment of the protection device 14 is desired, such as a vehicle collision, the sensor 51 provides a signal to each inflator 100, 104. Upon receiving the signal from the sensor 51, the inflators 100, 104 are actuated and provide inflation fluid to the air bag 16 and knee bolster 18 in a known manner. The inflating air bag 16 and knee bolster 18 pressurize and inflate sufficient to rupture portions of the housing 32, allowing the air bag and knee bolster to each inflate from the stored condition (FIG. 2) to the deployed condition (FIG. 1). The air bag 16 and knee bolster 18, while inflated, help protect the occupant 20 from impacts with parts of the vehicle 12, such as the instrument panel 36. More specifically, the air bag 16 can help protect the occupant's head 50, torso 52, pelvis 54, and hips 56 from impacts with upper portions of the instrument panel. The knee bolster 18 can help protect the occupant's legs 58 (upper leg portion 60, lower leg portion 62, and knees 64), pelvis 54, and hips 56 from impacts with lower portions of the instrument panel.

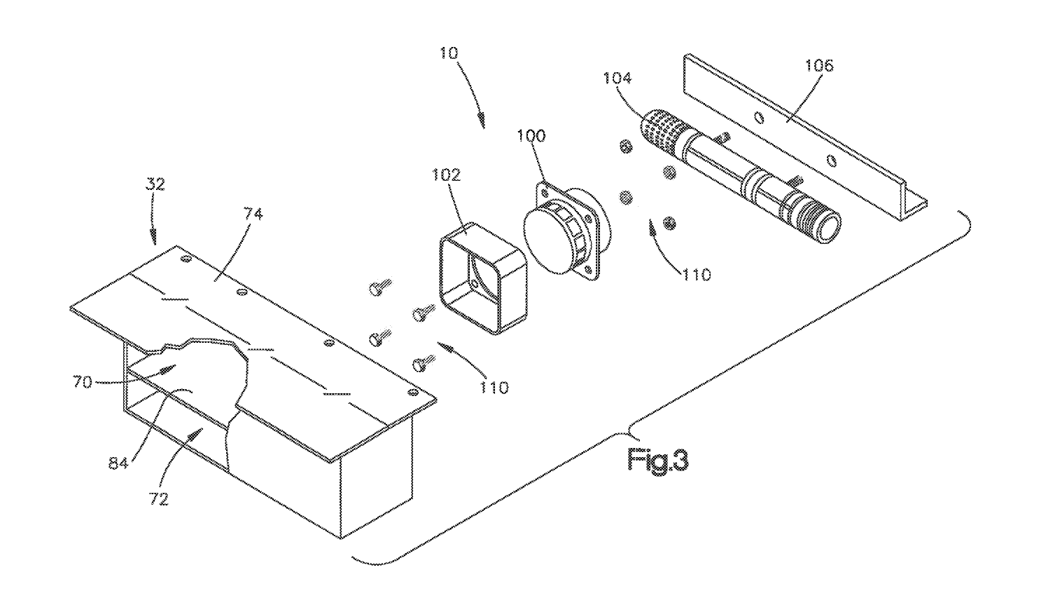

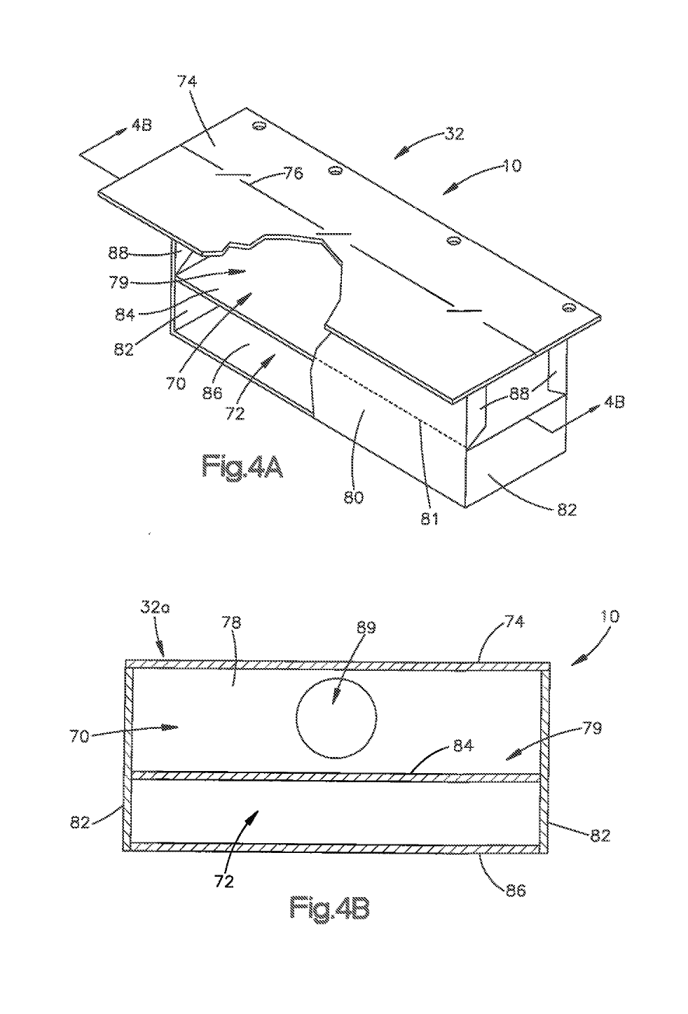

The air bag module 30 is illustrated in FIG. 3. The module 30 includes a housing 32 for enclosing the protection device 14 (not shown in FIG. 3). The housing 32 has a rectangular shape but may have an alternative shape, e.g., circular or polygonal. Referring further to FIGS. 4A-4B, the housing 32 includes a top wall 74, bottom wall 86, side walls 82, front wall 80, and rear wall 78 that cooperate to define an interior space 79. The rear wall 78 includes an opening 89 extending entirely therethrough to the interior space 79.

A dividing wall 84 positioned in the housing 32 separates the interior 79 into an air bag housing chamber 70 and a knee bolster housing chamber 72. The dividing wall 84 is configured such that the chambers 70, 72 are stacked on top of one another within the housing 32. The dividing wall 84 extends between the front wall 80 and the rear wall 78. The protection device 14 is divided between the chambers 70, 72 by the dividing wall 84 such that the air bag 16 is positioned entirely within the air bag housing chamber and the knee bolster 18 is positioned entirely within the knee bolster housing chamber 72.

The air bag chamber 70 is closed by the top wall 74, which includes a rupturable tear seam 76 configured to rupture when a predetermined force is applied to the top wall. In particular, the tear seam 76 ruptures in response to deployment of the air bag 16 to open the air bag chamber 70 and allow the air bag to deploy through the top wall 74.

The knee bolster chamber 72 is closed by the front wall 80, which includes a rupturable tear seam 81 configured to rupture when a predetermined force is applied to the front wall. In particular, the tear seam 81 ruptures in response to deployment of the knee bolster 18 to open the knee bolster chamber 72 and allow the knee bolster to deploy through the front wall 80 below the dividing wall 84. In another example, the dividing wall 84 may include a rupturable tear seam (not shown) that allows the knee bolster 18 to deploy through the dividing wall, out of the knee bolster chamber 72, though the air bag chamber 70, and of the housing 32 through the top wall 74 ruptured by the air bag 16.

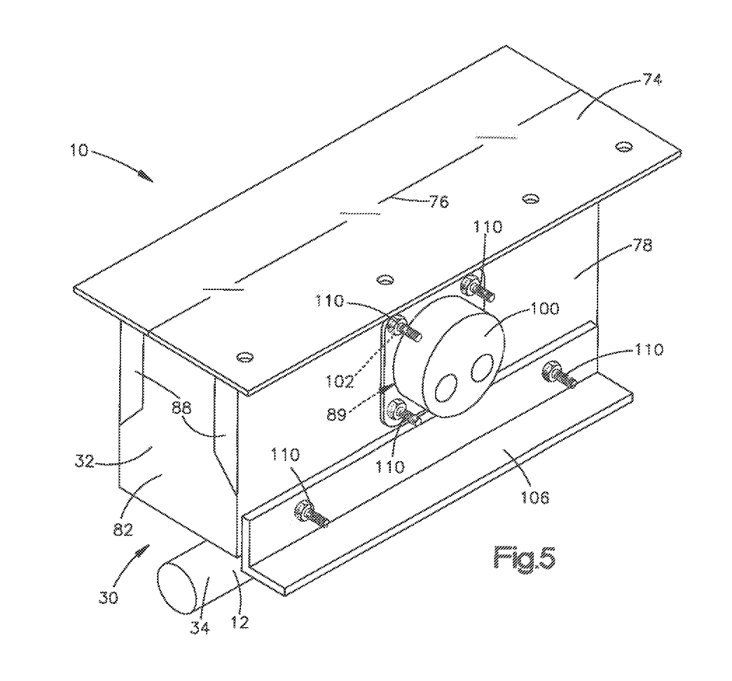

As shown in FIG. 3, the inflators used to inflate the protection device 14 constitute an air bag inflator 100 for inflating the air bag 16 and a knee bolster inflator 104 for inflating the knee bolster 18. A reaction canister 102 receives and supports the air bag inflator 100. The air bag inflator 100 and reaction canister 102 cooperate to secure the air bag 16, air bag inflator, and canister 102 to the rear wall 78 of the housing 32 via fasteners 110 (see also FIG. 5). More specifically, the reaction canister 102 is positioned adjacent the opening 89 on the inside of the rear wall 78. The air bag inflator 100 is positioned adjacent the opening 89 on the outside of the rear wall 78 and extends through the opening into the reaction canister 102 and the interior space 79. The air bag 16 is positioned between the reaction canister 102 and the inner side of the rear wall 78 within the interior space 79. The air bag inflator 100, air bag 16, and reaction canister 102 are secured to the rear wall 78 with the fasteners 110 such that the air bag inflator extends into the inflatable volume 37 of the air bag.

A mounting bracket 106 receives and supports the knee bolster inflator 104. The knee bolster inflator 104 and bracket 106 cooperate to secure the knee bolster 18, knee bolster inflator, and bracket to the rear wall 78 via fasteners 110. More specifically, the bracket 106 is positioned adjacent the outside of the rear wall 78 below the reaction canister 102. The knee bolster inflator 104 is positioned within the interior space 79 such that the knee bolster 18 is positioned between the knee bolster inflator and the inner side of the rear wall 78 within the interior space. The knee bolster inflator 104, knee bolster 18, and bracket 106 are secured to the rear wall 78 with the fasteners 110 such that the knee bolster inflator is positioned within the inflatable volume 37 of the knee bolster.

The bracket 106 also secures the air bag module 30 to the vehicle structure 34 via fasteners (not shown) or the like. The air bag inflator 100 and reaction canister 102 can be connected to the bracket 106 and thus to the vehicle structure 34 by way of the mutual connections of the bracket and the inflator/canister with the rear wall 78 of the housing 32. To improve or bolster this connection, the rear wall 78 of the housing 32 can include a rigid metal or plastic portion or be reinforced by a rigid metal or plastic portion (not shown). Alternatively or additionally, the reaction canister 102 and bracket 106 can be secured directly to one another (not shown).

Due to the connection of the reaction canister 102 and bracket 106 to the vehicle structure 34 the reaction canister and bracket act as reaction surfaces and remain substantially in place while the inflators 100, 104 actuate and pressurize the air bag 14 and knee bolster 18, respectively. The connection to the vehicle 34 by the reaction canister 102 and bracket 106 also allows the air bag 16 and knee bolster 18 to inflate and deploy in a controlled manner away from the rear wall 78 of the housing 32, out of the air bag chamber 70 and knee bolster chamber 72, and toward the respective portions of the occupant 20.

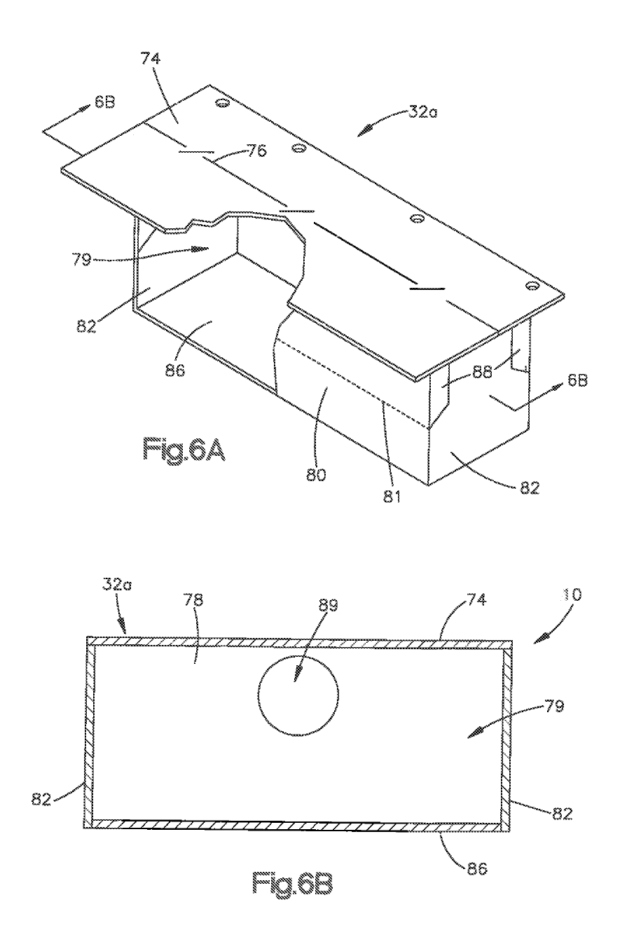

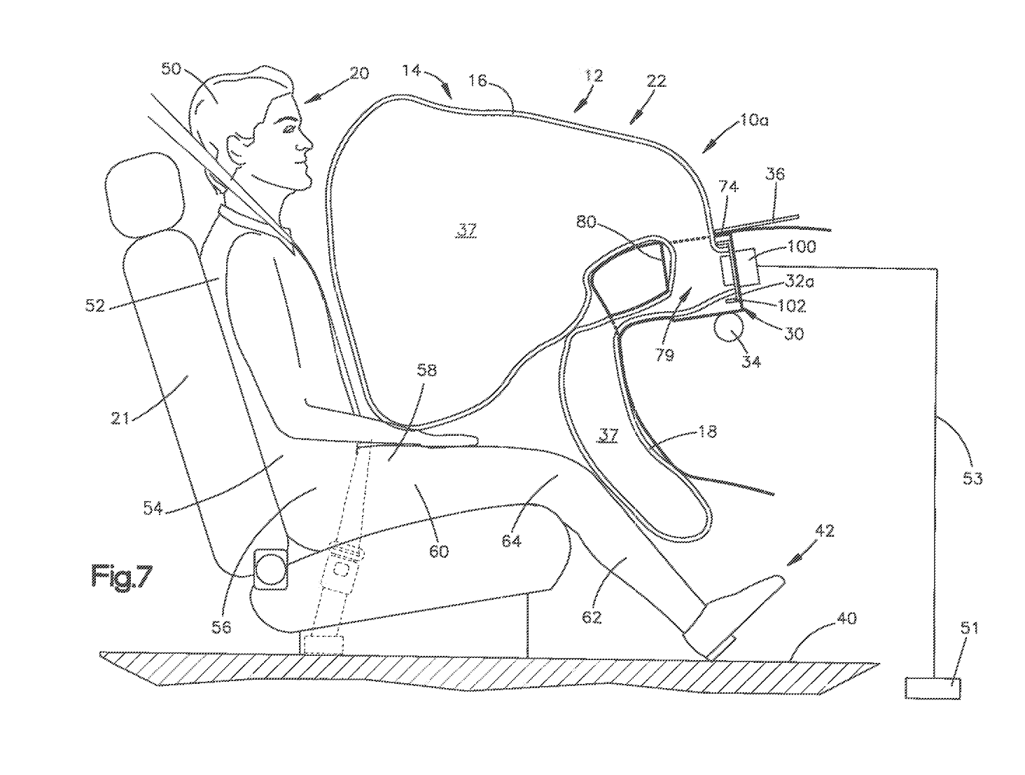

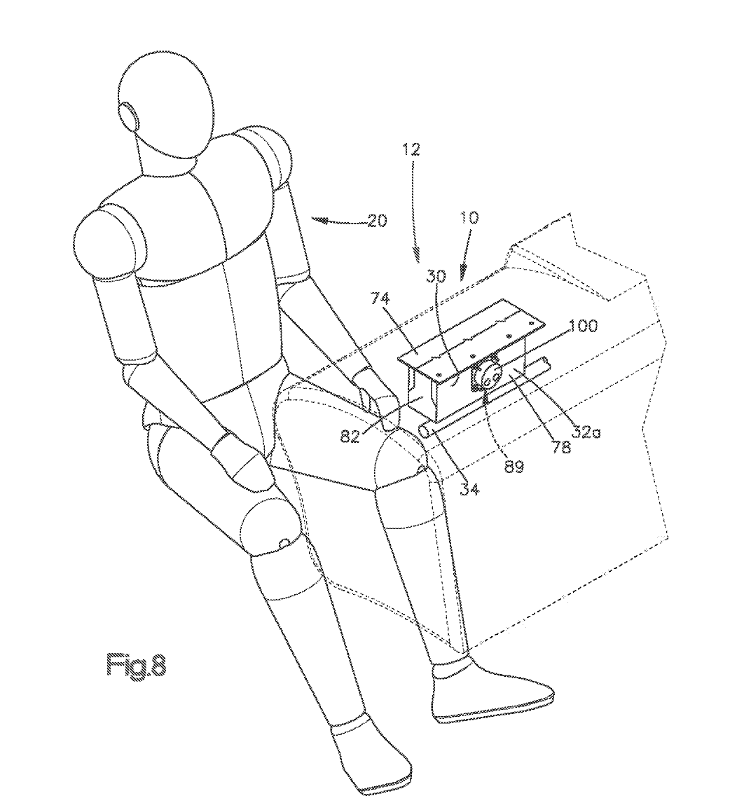

FIGS. 6A-8 illustrate an apparatus 10a in accordance with another embodiment of the present invention. In the apparatus 10a, the dividing wall 84 of the housing 32a is omitted such that the interior space 79 of the housing constitutes a single chamber. When this housing 32a configuration is used, the protection device 14a is formed as a single, integrally formed bag with one inflatable volume 37. In other words, the interiors of the air bag 16 and knee bolster 18 are fluidly connected together to form the inflatable volume 37. The single air bag forming the air bag 16 and the bolster 18 are both stored within the interior space 79 of the housing 32a. Furthermore, the knee bolster inflator 104 is omitted and the air bag inflator 100 is used to inflate both the air bag 16 and the knee bolster 18. The protection device 14a inflates and deploys out of the housing 32a towards the respective portions of the occupant 20 in the same manner as the protection device 14 of FIGS. 1-5.

Advantageously, the housing 32, 32a of the present invention has a construction in which all or part of the housing is constructed of a flexible material, such as fabric or carbon fiber. By “flexible”, it is meant that the housing 32, 32a has a size and shape that is readily changed or altered without plastically deforming the housing material. This flexible housing construction is in contrast to the rigid plastic or steel constructions typically used to enclose air bags and knee bolsters. Fabric used for the housing 32, 32a can, for example, be a nylon, heavyweight nylon or polyester fabric. The fabric can be reinforced, such as by aramid fibers.

The shape of the flexible housing 32, 32a during operation of the apparatus 10 of the present invention is due largely in part to the interior space 79 being filled with other components of the apparatus, e.g., the protection device 14, inflators 100, 104, and bracket 102, depending on the particular embodiment. In other words, but for the interior space 79 being filled with components of the apparatus 10 the housing 32, 32a would partially or fully collapse inwards under its own weight.

Referring to FIG. 4, due to their flexible construction, the walls 74, 78, 80, 82, 86 of the housing 32, 32a can be interconnected by means, such as stitching or adhesive. These interconnections secure the top wall 74, bottom wall 86, side walls 82, front wall 80, rear wall 78, and dividing wall 84 together along the lines of intersection illustrated in FIG. 4. To facilitate interconnection between the various housing walls 74, 78, 80, 82, 84, any or all of the walls can include tabs 88 that overlap the adjacent wall(s) and provide a space within which to place the interconnections, i.e., stitching. As shown, the front wall 80 and rear wall 78 each include a pair of tabs 88 that fold over to overlap each side wall 82. Stitching then connects the front wall 80 and rear wall 78 to the side walls 82 along the tabs 88. Any number of tabs 88 may be used to help secure the walls 74, 78, 80, 82, 84 together. In another example, peripheries of the intersecting walls 74, 78, 80, 82, 84 can be pinched together to form overlying portions (not shown) that are then stitched together to form the housing 32, 32a. When the housing 32, 32a is formed from a carbon fiber material ultrasonic welding can be used to form the interconnections between walls 74, 78, 80, 82, 84.

Advantageously, the flexible housing 32, 32a of the present invention can withstand the forces exerted on its structure during pressurization and deployment of the air bag 16 and knee bolster 18. The flexible construction of the housing 32, 32a, and any reinforcing fibers or other materials used therein, lead to this capability. In other words, the flexible construction enables the housing 32, 32a to maintain structural integrity during storage, pressurization, and deployment of the protection device 14 and exhibit similar mechanical properties to conventional, rigid plastic or steel housings used for air bag and knee bolsters. Consequently, the flexible housing 32, 32a can direct deployment of the air bag 16 and knee bolster 18 in a controlled manner similar or identical to the manner in which conventional, rigid housings direct such deployment. To this end, the inclusion of the dividing wall 84 can, in addition to dividing the interior 79 of the housing 32 into chambers 70, 72, reinforce the side walls 82, front wall 80, and rear wall 78 to help further prevent deflection thereof under the force of protection device 14 deployment, thereby improving the structural integrity of the housing 32.

The flexible housing 32, 32a construction of the present invention is also advantageous in that it eliminates separate modules for the air bag 16 and knee bolster 18, which can reduce the volume occupied by the module 30 within the vehicle 12. Furthermore, the flexible housing 32, 32a is far lighter than plastic and/or steel counterparts. The flexible housing 32, 32a is also readily adaptable to broad vehicle architecture designs, which enables providing a more spacious occupant cabin. Moreover, the assembly line for the combined module 30 would eliminate the need for dual lines for separate modules, thereby reducing labor costs.

From the above description of the invention, those skilled in the art will perceive improvements, changes and modifications. Such improvements, changes and modifications within the skill of the art are intended to be covered by the appended claims.

Having described the invention, the following is claimed:

1. An apparatus for helping to protect an occupant of a vehicle, the apparatus comprising:
an air bag inflatable between an occupant's head/torso and an instrument panel of the vehicle;
a knee bolster inflatable between the occupant's legs/pelvis and the instrument panel; and
a flexible housing for supporting both the air bag and the knee bolster within the instrument panel.

2. The apparatus recited in claim 1, wherein the housing is formed from fabric.

3. The apparatus recited in claim 2, wherein the fabric comprises nylon.

4. The apparatus recited in claim 2, wherein the fabric comprises polyester.

5. The apparatus recited in claim 2, wherein the fabric is reinforced with aramid fibers.

6. The apparatus recited in claim 1, wherein the housing is formed from carbon fiber.

7. The apparatus recited in claim 1, wherein the housing comprises intersecting walls, at least one of the walls including one or more tabs that extend across the intersection and overlie the adjacent wall, the tabs being secured to the adjacent housing wall to connect the intersecting walls and form the housing.

8. The apparatus of claim 7, wherein the tabs are secured to the adjacent wall with stitching to interconnect the intersecting walls.

9. The apparatus recited in claim 1, wherein the housing comprises intersecting carbon fiber walls ultrasonically welded together to form the housing.

10. The apparatus recited in claim 1, wherein a first wall of the housing includes a rupturable tear seam for rupturing in response to deployment of the air bag and a second wall of the housing includes a rupturable tear seam for rupturing in response to deployment of the knee bolster.

11. The apparatus recited in claim 1, further comprising a first inflator for inflating the air bag and a second inflator for inflating the knee bolster, the first and second inflators being connectable to a wall of the housing to connect the inflators, the air bag, and the knee bolster to the housing.

12. The apparatus recited in claim 11, wherein the first inflator cooperates with a reaction canister to connect the first inflator and the air bag to the housing.

13. The apparatus recited in claim 11, wherein the second inflator cooperates with a bracket to connect the second inflator and the knee bolster to the housing.

14. The apparatus recited in claim 13, wherein the bracket also connects the apparatus to the vehicle.

15. The apparatus recited in claim 1, wherein the housing comprises separate air bag and knee bolster chambers for housing the air bag and knee bolster, respectively.

16. The apparatus recited in claim 15, wherein the housing includes a dividing wall that divides the interior of the housing to help define the separate air bag and knee bolster chambers.

17. The apparatus recited in claim 1, wherein the air bag and the knee bolster form a single inflatable volume.

18. The apparatus recited in claim 17 further comprising a single inflator for inflating both the air bag and the knee bolster.

19. An apparatus for helping to protect an occupant of a vehicle, the apparatus comprising:
an air bag inflatable between an occupant's head/torso and an instrument panel of the vehicle;
a knee bolster inflatable between the occupant's legs/pelvis and the instrument panel, air bag and knee bolster being integrally formed together and cooperating to define a single inflatable volume; and
a fabric housing for supporting both the air bag and the knee bolster within the instrument panel.
